(19) United States
(12) Patent Application Publication
(10) Pub. No.: US 2023/0071760 A1
(43) Pub. Date: Mar. 9, 2023

(54) CALIBRATING CONFIDENCE OF CLASSIFICATION MODELS

(71) Applicant: Intel Corporation, Santa Clara, CA (US)

(72) Inventors: Anthony Daniel Rhodes, Portland, OR (US); Sovan Biswas, Bonn (DE); Giuseppe Raffa, Portland, OR (US)

(73) Assignee: Intel Corporation, Santa Clara, CA (US)

(21) Appl. No.: 18/050,929

(22) Filed: Oct. 28, 2022

(51) Int. Cl. G06N 3/08; G06N 3/04

(52) U.S. Cl. CPC G06N 3/08; G06N 3/04

(57) ABSTRACT

Disclosed is a technical solution to calibrate confidence scores of classification networks. A classification network has been trained to receive an input and output a label of the input that indicates a class of the input. The classification network also outputs a confidence score of the label, which indicates a likelihood of the input falling into the class, i.e., a confidence level of the classification network that the label is correct. To calibrate the confidence of the classification network, a logit transformation function may be added into the classification network. The logic transformation function may be an entropy-based function and have learnable parameters, which may be trained by inputting calibration samples into the classification network and optimizing a negative log likelihood based on the labels generated by the classification network and ground-truth labels of the calibration samples. The trained logic transformation function can be used to compute reliable confidence scores.

### TECHNICAL FIELD

This disclosure relates generally to classification models, and more specifically, calibrating confidence of classification models, e.g., deep neural networks (DNNs).

### BACKGROUND

DNNs are used extensively for a variety of artificial intelligence (AI) applications ranging from computer vision to speech recognition and natural language processing due to their ability to achieve high accuracy. Many DNNs are developed to focus on classification, e.g., image classification. With advancements in deep learning technologies, accuracy of DNNs is getting better. DNNs are becoming components of many decision-making pipelines, such as medical diagnosis, object detection, speech recognition, and so on.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a classification network, in accordance with various embodiments.

FIG. 2 illustrates a classification network with confidence calibration, in accordance with various embodiments.

FIG. 3 illustrates calibrated probabilities determined by a multi-class classifier, in accordance with various embodiments.

FIG. 4 is a block diagram of a DNN system, in accordance with various embodiments.

FIG. 5 is a block diagram of a calibration module, in accordance with various embodiments.

FIG. 6 is a flowchart showing a method of confidence calibration, in accordance with various embodiments.

FIG. 7 illustrates an example DNN, in accordance with various embodiments.

FIG. 8 illustrates a deep learning environment, in accordance with various embodiments.

FIG. 9 is a block diagram of an example computing device, in accordance with various embodiments.

### DETAILED DESCRIPTION

Overview

The last decade has witnessed a rapid rise in AI based data processing, particularly based on DNN. DNNs are widely used in the domains of computer vision, speech recognition, image, and video processing mainly due to their ability to achieve beyond human-level accuracy. Many DNNs are developed to classify objects, e.g., from images. These DNNs typically output classes of detected objects and confidence scores that indicate probabilities of the detected objects falling into the classes. The confidence scores measure how confident the DNNs are that the classes determined by the DNNs are correct. The confidence scores can be valuable information in many applications. For instance, the confidence scores can suggest whether the classification done by the DNNs are sufficiently reliable for making decisions or whether other information should be used to make decisions.

Confidence calibration of a classification model is the problem of predicting probability estimates that are well-aligned with true model performance. For instance, if a model is 80% confident in its class prediction for an input datum, we wish for this 80% confidence measure to reflect the true likelihood of a correct prediction in this instance. Favorable calibration properties are vital to the viability of real-world, deployable AI systems. This may be particularly true for application domains that encompass safety critical use cases (e.g., autonomous vehicles, manufacturing, etc.), application domains that impact executive decision processes (e.g., AI for policy making, etc.), or systems that rely on accurate uncertainty measures and human-in-the-loop functionality (e.g., AI-assisted medical diagnostics, etc.). Calibrated confidence measures can also be important for facilitating effective model interpretability and anomaly detection methods.

Despite the recent, precipitous improvements in classification performance across state-of-the-art models, many strongly performant models suffer from poor calibration properties, which severely limits the feasibility of their deployment in many real-world use cases. For instance, large-scale models manifest overfitting through poor calibration and can become overconfident. Therefore, confidence calibration for classification models is important.

Embodiments of the disclosure provide a technical solution for calibrating confidence of DNNs. In various embodiments of the disclosure, an entropy-based calibration function may be used to calibrate confidence scores of classification networks. The calibration function may also be referred to as a logit transformation function, which can perform per-datum logit transformation.

To calibrate the confidence of a classification network, the calibration function may be associated with the classification network after the classification network is trained. The classification network is trained to receive an input and output a label of the input that indicates a class of the input. The classification network also outputs a confidence score of the label, which indicates a likelihood of the input falling into the class, i.e., a confidence level of the classification network that the label is correct. The calibration function may be incorporated into the output layer of the classification network. The output layer receives logits generated by hidden layers of the classification network. The output layer may perform a logit transformation based on the calibration function and compute a calibrated confidence score after the logit transformation. In embodiments where the classification network selects the label of an input from multiple classes based on the confidence scores for each of the classes, the calibration function can preserve the maximum confidence score so that the selection of the label would not be impacted by the incorporation of the calibration function. With the calibration function, the classification network may output the same label for the same input, but the level of confidence of the classification network for the label is more reliable.

The calibration function may be a learnable function that includes one or more learnable parameters. In some embodiments, the calibration function may include two learnable parameters. The values of the learnable parameters may be optimized by training the calibration function. To train the calibration function, calibration samples may be input into the classification network. The values of the learnable parameters may be optimized by minimizing a negative log likelihood (NLL) based on labels of the calibration samples generated by the classification network and the ground-truth labels of the calibration samples. The process of training the calibration function may be integrated with a process of verifying an accuracy of the classification network. The accuracy may be indicated by a ratio of the number of calibration samples that the classification network correctly classified to the total number of calibration samples. The accuracy may be verified based on the labels of the calibration samples generated by the classification network and the ground-truth labels of the calibration samples. In some embodiments, the calibration samples are different from training samples used for training the classification network. The number of calibration samples may be less than the number of training samples. For instance, the number of calibration samples may be 5-10% of the number of training samples.

The disclosure provides a post-training entropy-based calibration function that can effectively improve classification calibration properties while preventing model performance degradation. The calibration function can facilitate a maximum-preserving, non-linear logit transformation. Compared with previous calibration method (such as temperature scaling that learns a single tunable parameter that is applied irrespective of the class prediction and uncalibrated predictive uncertainty), the calibration function in this disclosure can smooth logit distributions in a more refined and sophisticated manner. The calibration function introduces no additional compute or memory requirements during training. Also, as the calibration function may have two trainable parameters, it necessitates the approximate solution of a relatively low dimensional optimization problem. The calibration function can be applied to various types of classifiers, e.g., DNN, SVM (support vector machine), and so on. Thus, the disclosure provides an effective and generalizable solution for improving the practical viability of classification models.

For purposes of explanation, specific numbers, materials and configurations are set forth in order to provide a thorough understanding of the illustrative implementations. However, it will be apparent to one skilled in the art that the disclosure may be practiced without the specific details or/and that the disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the disclosure, the phrase “A and/or B” means (A), (B), or (A and B). For the purposes of the disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example Classification Networks

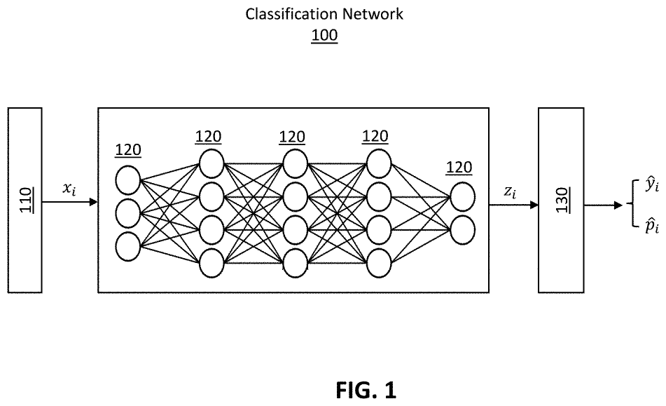

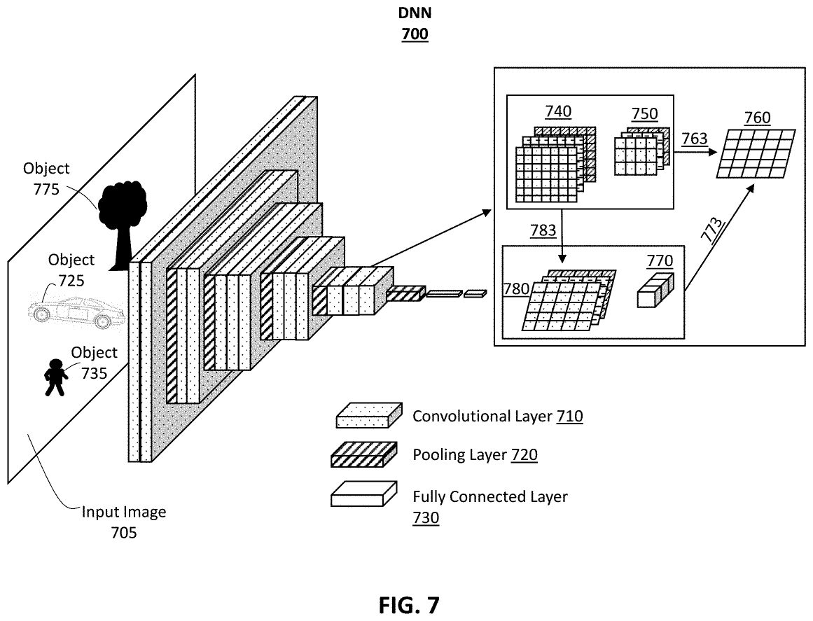

FIG. 1 illustrates a classification network 100, in accordance with various embodiments. The classification network 100 has been trained to receive inputs and outputs classifications of the inputs. In some embodiments, the classification network 100 may output multiple classifications for an input and determine confidence scores of the classifications. A confidence score of a classification of an input indicates the probability that the classification of the input is correct. An example of the classification network 100 is the DNN 700 in FIG. 7. As shown in FIG. 1, the classification network 100 includes an input layer 110, hidden layers 120 (individually referred to as “hidden layer 120”), and an output layer 130. For purpose of illustration, FIG. 1 shows five hidden layers 120. In other embodiments, the classification network 100 may include fewer, more, or different layers.

The input layer 110 receives inputs to the classification network 110. Examples of inputs may be image, text, video, audio, or other types of data. The input layer 110 may receive multiple inputs at a time. In some embodiments, the inputs may be different portions of a data file, e.g., different portions of an image, different frames of a video, different sections of a text document, and so on. An input in denoted as xᵢ in FIG. 1, where i denotes the index of the input within a group of inputs. The input layer 110 provides the input xᵢ to the hidden layers 120.

The hidden layers 120 process the input xᵢ. For instance, some or all of the hidden layers 120 may extract features from the input xᵢ. The hidden layers 120 may include convolutional layers, pooling layers, fully connected layers, linear layers, and so on. The hidden layers 120 may perform one or more types of deep learning operations on the input xᵢ. Examples of deep learning operations include convolutions, pooling operations, elementwise operations (e.g., elementwise addition, elementwise multiplication, etc.), other types of deep learning operations, or some combination thereof. The hidden layers 120 may have internal parameters, which are used in the deep learning operations. Values of the internal parameters may be determined by training the classification network 100. In some embodiments, the hidden layers 120 are arranged in a sequence. The first hidden layer 120 in the sequence receives the input xᵢ and may output a feature map from the input xᵢ. The output of the first hidden layer 120 may be fed into the second hidden layer for further processing. This may continue till the last hidden layer 120 processes the output from the last second hidden layer 120 and generates an output.

The output of the last hidden layer 120, which is generated based on the input xᵢ, may be a logit zᵢ. In some embodiments (e.g., embodiments where the classification network 100 is a single class classifier), the logit zᵢ may include a single number. In other embodiments (e.g., embodiments where the classification network 100 is a multi-class classifier), the logit zᵢ may include a plurality of numbers. The numbers in the logit zᵢ may be arranged in columns, or columns and row. A number in the logit zᵢ may have a positive, zero, or negative value. The logit zᵢ is fed into the output layer 130. The output layer 120 processes the logit zᵢ and outputs a class ŷᵢ of the input xᵢ. In some embodiments, the class ŷᵢ may be generated by using an argmax function, which may be denoted as:

ŷᵢ=argmaxₖzᵢ^{(k)}

where k denotes the index of a single class.

The output layer 130 may also include a softmax function for computing a confidence score \hat{p}ᵢ of the class ŷᵢ. The confidence score \hat{p}ᵢ indicates a probability that the input xᵢ belongs to the class ŷᵢ, i.e., how confident the classification network 100 is for the classification of the input xᵢ. The determination of the confidence score \hat{p}ᵢ with the softmax function may be denoted as:

$${σ}_{S M} = \frac{exp ( {z}_{i}^{( k )} )}{{\sum }_{j = 1}^{K} exp ( {z}_{i}^{( k )} )}$$

$${\hat{p}}_{i} = {max}_{k} {{σ}_{S M} ( {z}_{i} )}^{( k )}$$

where K denotes the total number of classes, k denotes one of the K classes, σ_{SM} denotes the softmax function, σ_{SM}(zᵢ)^{(k)} denotes a probability of the input xᵢ falling into the k class, ŷᵢ denotes the class of the input xᵢ, and \hat{p}ᵢ denotes the confidence score for the class ŷᵢ.

The confidence score \hat{p}ᵢ can be important in certain applications of the classification network 100. These applications requires that the classification network 100 is not just accurate (e.g., able to predict the correct class) but should also be able to indicate how confident the classification network is about its output. In an example where the classification network 100 is used in a system of a self-driving car, the system needs to know when the classification network 100 is likely to be incorrect so that the system can rely on other data to control the car. In another example where the classification network 100 is used in a medical diagnostic system, the system needs to know when the confidence of the classification network 100 is not high enough so that the system can request opinions from a human doctor. However, the confidence score \hat{p}ᵢ may not be well calibrated, e.g., due to the depth or width of the architecture of the classification network 100. Calibration of the confidence score \hat{p}ᵢ may be needed to improve performance of the classification network 100 in certain applications.

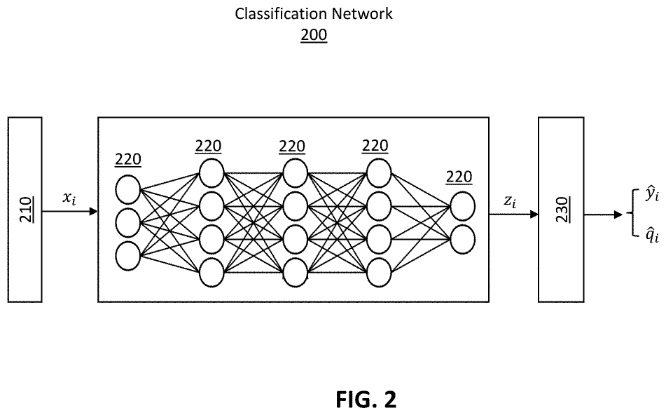

FIG. 2 illustrates a classification network 200 with confidence calibration, in accordance with various embodiments. The classification network 200 has been trained to receive inputs and outputs classifications of the inputs. In some embodiments, the classification network 200 may output multiple classifications for an input and determine confidence scores of the classifications. A confidence score of a classification of an input indicates the probability that the classification of the input is correct. An example of the classification network 200 is the DNN 700 in FIG. 7. As shown in FIG. 2, the classification network 200 includes an input layer 210, hidden layers 220 (individually referred to as “hidden layer 220”), and an output layer 230. For purpose of illustration, FIG. 2 shows five hidden layers 220. In other embodiments, the classification network 200 may include fewer, more, or different layers.

The input layer 210 receives inputs to the classification network 210. Examples of inputs may be image, text, video, audio, or other types of data. The input layer 210 may receive multiple inputs at a time. In some embodiments, the inputs may be different portions of a data file, e.g., different portions of an image, different frames of a video, different sections of a text document, and so on. An input in denoted as xᵢ in FIG. 2, where i denotes the index of the input within a group of inputs. The input layer 210 provides the input xᵢ to the hidden layers 220.

The hidden layers 220 process the input xᵢ. For instance, some or all of the hidden layers 220 may extract features from the input xᵢ. The hidden layers 220 may include convolutional layers, pooling layers, fully connected layers, linear layers, and so on. The hidden layers 220 may perform one or more types of deep learning operations on the input xᵢ. Examples of deep learning operations include convolutions, pooling operations, elementwise operations (e.g., elementwise addition, elementwise multiplication, etc.), other types of deep learning operations, or some combination thereof. The hidden layers 220 may have internal parameters, which are used in the deep learning operations. Values of the internal parameters may be determined by training the classification network 200. In some embodiments, the hidden layers 220 are arranged in a sequence. The first hidden layer 220 in the sequence receives the input xᵢ and may output a feature map from the input xᵢ. The output of the first hidden layer 220 may be fed into the second hidden layer for further processing. This may continue till the last hidden layer 220 processes the output from the last second hidden layer 220 and generates an output.

The output of the last hidden layer 220, which is generated based on the input xᵢ, may be a logit zᵢ. In some embodiments (e.g., embodiments where the classification network 200 is a single class classifier), the logit zᵢ may include a single number. In other embodiments (e.g., embodiments where the classification network 200 is a multi-class classifier), the logit zᵢ may include a plurality of numbers. The numbers in the logit zᵢ may be arranged in columns, or columns and row. A number in the logit zᵢ may have a positive, zero, or negative value.

The logit zᵢ is fed into the output layer 230. The output layer 230 has a logit transformation function for calibrating confidence scores. The logit transformation function may be denoted as:

$$f ( {z}_{i} ) = \frac{{z}_{i}}{{τ}_{0} + {τ}_{1} \cdot H ( {σ}_{S M} ( {z}_{i} ) )}$$

where τ₀ and τ₁ are two learnable parameters, and H(σ_{SM}(zᵢ)) is a per-datum entropy following the softmax operation σ_{SM}(zᵢ). In some embodiments, the entropy for the point mass function implied by the distribution of X may be denoted as:

H(X)=−Σ_{x∈X}p(x)log p(x)

The values of the two learnable parameters τ₀ and τ₁ may be determined through a training of the logit transformation function. The training of the logit transformation function may be performed after the training of the classification network 200, using a different dataset from the dataset used to train the classification network 200. The two learnable parameters τ₀ and τ₁ may have non-negative values. The logit transformation function may smooth logit distribution.

In some embodiments, the output layer 230 may determine a class ŷᵢ based on the transformed logit f(zᵢ), which may be denoted as:

ŷᵢ=argmaxₖf(zᵢ)^{(k)}

where k denotes the index of a single class. The output layer 230 can compute a calibrated confidence score \hat{q}ᵢ of the class ŷᵢ. The confidence score \hat{q}ᵢ indicates a probability that the input xᵢ belongs to the class ŷᵢ, i.e., how confident the classification network 200 is for the classification of the input xᵢ. The determination of the confidence score \hat{q}ᵢ with the softmax function may be denoted as:

$${σ}_{S M} = \frac{exp ( {f ( {z}_{i} )}^{( k )} )}{{\sum }_{j = 1}^{K} exp ( {f ( {z}_{i} )}^{( k )} )}$$

$${\hat{q}}_{i} = {max}_{k} {{σ}_{S M} ( {f ( {z}_{i} )}^{( k )} )}^{( k )}$$

where K denotes the total number of classes, k denotes one of the K classes, σ_{SM} denotes the softmax function, σ_{SM}(zᵢ)^{(k)} denotes a probability of the input xᵢ falling into the k class, ŷᵢ denotes the class of the input xᵢ, and \hat{q}ᵢ denotes the calibrated confidence score for the class ŷᵢ.

In some embodiments, the values of the two learnable parameters τ₀ and τ₁ are above zero. As the entropy is also a non-negative number, the logit transformation function is maximum preserving. For the same input xᵢ, the classification network 200 may detect the same class ŷᵢ as the classification network 100. The accuracy of the classification network 200 may be the same as the classification network 100. However, the confidence score \hat{q}ᵢ is better calibrated than the confidence score \hat{p}ᵢ, which may render the classification network 200 more reliable than the classification network 100. In some embodiments, compared with the confidence score \hat{p}ᵢ, the confidence score \hat{q}ᵢ is closer to the accuracy of the classification network. In an example, the confidence score \hat{q}ᵢ may be substantially similar to the accuracy of the classification network 200, versus the confidence score \hat{p}ᵢ is noticeably larger than the accuracy of the classification network 100, which indicates that the classification network 100 is overconfident.

In some embodiments, due to the logit transformation, larger predictive uncertainty can enforce a more severe logit smoothing. As H(X) increases, the logit transformation induces larger reduction in magnitude corresponding with the maximum magnitude logit index (out of all logit indices). In other words, when the classification network 200 is less confident of its classification, the highest magnitude classification is reduced the most, which can be the desired outcome to help improve confidence calibration.

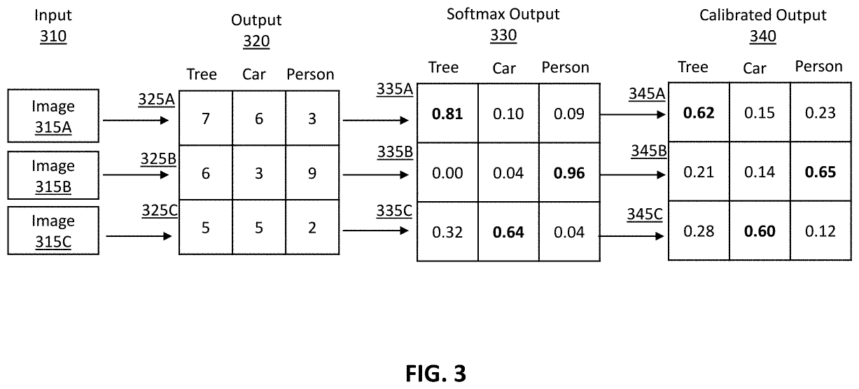

FIG. 3 illustrates calibrated probabilities determined by a multi-class classifier, in accordance with various embodiments. An example of the multi-class classification model is the classification network 200 in FIG. 2. For purpose of illustration, FIG. 3 shows example detection of objects in an input 310 including three images 315A-315C (collectively referred to as “images 315” or “image 315”). In an example where the input 310 is a video, the three images 315 may be frames in the video. In another example where the input 310 is an image, the three images 315 may be different pixels in the input 310. Each image 315 may captured one or more objects. The multi-class classification model may classify an object in an image 315 into one or more classes. In the embodiments of FIG. 3, the multi-class classification model processes three classes: tree, car, and person.

An output 320 includes three vectors 325A, 325B, and 325C (collectively referred to as “vectors 325” or “vector 325”). The vector 325A is generated from the image 315A, e.g., by hidden layers in the multi-class classifier. The vector 325B is generated from the image 315B, e.g., by hidden layers in the multi-class classifier. The vector 325C is generated from the image 315C, e.g., by hidden layers in the multi-class classifier. Each vector 325 may be an embodiment of the vector zᵢ described above in conjunction with FIG. 2. Each vector 325 includes three elements corresponding to the three classes, respectively.

A softmax output 330 includes a matrix generated from the output 320 by using a softmax function. The softmax output 330 includes three vectors 335A, 335B, and 335C (collectively referred to as “vectors 335” or “vector 335”). The vector 335A is generated from the vector 325A. The vector 335B is generated from the vector 325B. The vector 335C is generated from the vector 325C. Each vector 335 includes three elements corresponding to the three classes, respectively. Each element indicates a probability of an object in the corresponding image 315 falling into the corresponding class. The probability is a confidence score of the class of the object. In some embodiments (e.g., embodiments before or without confidence calibration), the class with the highest probability may be determined as the class of the image 315, and the highest probability may be determined as the confidence score of the multi-class classifier. Taking the image 315A for example, the multi-class classifier may determine that the class of the image 315 is tree, with a confidence score of 0.81. For the image 315B, the multi-class classifier may determine that the class is person, with a confidence score of 0.96. For the image 315C, the multi-class classifier may determine that the class is car, with a confidence score of 0.64.

The confidence scores in the softmax output 330 may be not reliable and may not be able to meet requirements of the applications where the multi-class classifier is used. A logit transformation function may be associated with an output layer of the multi-class classifier to transform the logits in the output 320, following the softmax operation, and smooth out the logit distribution in the output 320.

A calibrated output 340 is generated based on the logit transformation function and softmax function. The calibrated output 340 includes three vectors 345A, 345B, and 345C (collectively referred to as “vectors 345” or “vector 345”). The vector 345A is generated from the vector 325A. The vector 345B is generated from the vector 325B. The vector 345C is generated from the vector 325C. The multi-classifier outputs classes and confidence scores based on the calibrated output 340. The multi-class classifier determines that the class of the image 315 is tree with a confidence score of 0.62, that the class of the image 315B is person with a confidence score of 0.75, and that the class of the image 315C is car with a confidence score of 0.60. With the addition of the logit transformation function in the output layer of the multi-class classifier, the classes determined by the multi-class classifier remain the same but the confidence scores are changed. The confidence score for the class of the image 315B, which has the highest confidence score in the softmax output 330, has the biggest change, i.e., a decrease from 0.96 to 0.65. The confidence score for the class of the image 315C, which has the lowest confidence score in the softmax output 330, has the smallest change, i.e., a decrease from 0.64 to 0.60. The confidence scores in the calibrated output 340 may be closer to the accuracy of the multi-class classifier than the confidence scores in the output 330. The confidence scores in the calibrated output 340 can be more reliable, e.g., for high-stake applications where the multi-class classifier is used.

The numbers shown in FIG. 3 are for illustration only. The input 310, output 320, softmax output 330, or calibrated output 340 of the multi-class classifier may include different numbers. Also, the number of images in the input 310 or the number of classes processed by the multi-class classifier may be different in other embodiments. Also, the multi-class classifier may process other types of data than images.

Example DNN System

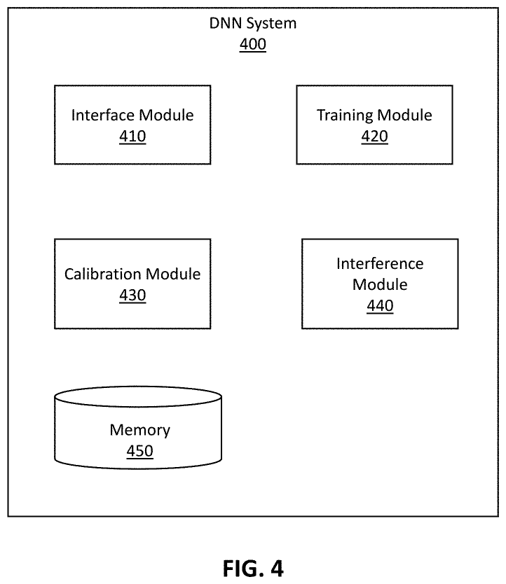

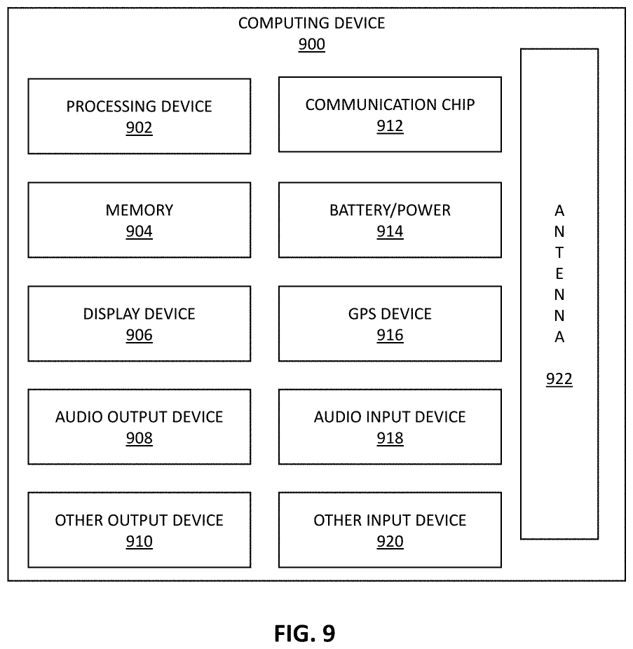

FIG. 4 is a block diagram of an example DNN system 400, in accordance with various embodiments. The whole DNN system 400 or a part of the DNN system 400 may be implemented in the computing device 900 in FIG. 9. The DNN system 400 trains DNNs for various tasks, such as image classification, learning relationships between biological cells (e.g., DNA, proteins, etc.), control behaviors for devices (e.g., robots, machines, etc.), and so on. The DNN system 400 includes an interface module 410, a training module 420, a calibration module 430, an inference module 440, and a memory 450. In other embodiments, alternative configurations, different or additional components may be included in the DNN system 400. Further, functionality attributed to a component of the DNN system 400 may be accomplished by a different component included in the DNN system 400 or a different system. The DNN system 400 or a component of the DNN system 400 (e.g., the training module 420 or inference module 440) may include the computing device 900.

The interface module 410 facilitates communications of the DNN system 400 with other systems. For example, the interface module 410 establishes communications between the DNN system 400 with an external database to receive data that can be used to train DNNs or input into DNNs to perform tasks. As another example, the interface module 410 supports the DNN system 400 to distribute DNNs to other systems, e.g., computing devices configured to apply DNNs to perform tasks.

The training module 420 trains DNNs by using a training dataset. The training module 420 forms the training dataset. The training dataset may include a plurality of training samples and ground-truth labels of the training samples. A training sample may be an input of the DNN. A training sample may be associated with one or more ground-truth labels, each of which may indicate a ground-truth class of the training sample. In an embodiment where the training module 420 trains an DNN to recognize objects in images, the training dataset includes training images and training labels. The training labels describe ground-truth classifications of objects in the training images. In some embodiments, each label in the training dataset corresponds to an object in a training image.

In some embodiments, a part of the training dataset may be used to initially train the DNN, and the rest of the training dataset may be held back as a calibration subset used by the calibration module 430 to calibrate confidence score and validate performance of a trained DNN. The portion of the training dataset not including the calibration subset may be used to train the DNN. In some embodiments, the calibration subset may be a relatively small portion of the training dataset. In an example, the calibration subset may include 5-10% of the training samples in the training dataset. The training samples in the calibration subset may be different from the rest of the training samples that is used for training the DNN.

The training module 420 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 4, 40, 500, 400, or even larger.

The training module 420 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different category by training.

In the process of defining the architecture of the DNN, the training module 420 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 420 defines the architecture of the DNN, the training module 420 inputs training samples into the DNN. The training module 420 modifies the parameters inside the DNN (“internal parameters of the DNN”) to minimize a difference between labels of the training samples are generated by the DNN and the ground-truth labels of the objects. The internal parameters may include weights of hidden layers (e.g., convolutional layers, linear layers, etc.) of the DNN. In some embodiments, the training module 420 uses a loss function to minimize the difference.

The training module 420 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 420 finishes the predetermined number of epochs, the training module 420 may stop updating the parameters in the DNN. The DNN having the updated parameters is referred to as a trained DNN.

The calibration module 430 may calibrate confidence scores of the DNN after the DNN is trained. In some embodiments, the calibration module 430 may associate a calibration function with the trained DNN. The calibration function may be a logit transformation function, such as the logit transformation function described above in conjunction with FIG. 2. The calibration module 430 may incorporate the calibration function into the output layer of the trained DNN. The calibration function may transform logits received by the output layer. The transformation of the logits by the calibration function may be per-datum, e.g., the calibration function may transform every logit separately. The calibration function can generate transformed logits, which may be used (e.g., by the output layer) to classify inputs and compute calibrated confidence scores of the classification.

The calibration function may be a trainable function. For instance, the calibration function may include two learnable parameters, the values of which may be determined by training the calibration function. In some embodiments, the calibration module 430 may train the calibration function by using a calibration dataset. The calibration dataset may include calibration samples and ground-truth labels of the calibration samples. An example of the calibration subset described above. The calibration module 430 may input the calibration samples into the trained DNN, and use a loss function to minimize a difference between the outputs of the trained DNN and the ground-truth labels of the calibration samples by adjusting the values of the two learnable parameters.

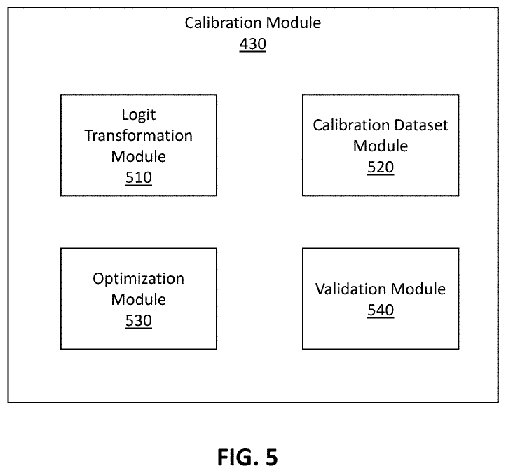

In some embodiments, the calibration process is also a validation process. The calibration function 430 may verify a performance (e.g., accuracy) of the trained DNN with the calibration dataset. Certain aspects of the calibration function are provided below in conjunction with FIG. 5.

The inference module 440 applies the trained or calibrated DNN to perform tasks. For instance, the inference module 440 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output which may be, for example, a class of the image, a listing of detected objects, a boundary of detected objects, or the like. In some embodiments, the inference module 440 distributes the DNN to other systems, e.g., computing devices in communication with the DNN system 400, for the other systems to apply the DNN to perform the tasks.

The memory 450 stores data received, generated, used, or otherwise associated with the DNN system 400. For example, the memory 450 stores the datasets used by the training module 420 and validation module 430. The memory 450 may also store data generated by the training module 420 and calibration module 430, such as the hyperparameters for training DNNs, internal parameters of trained DNNs, and so on. In the embodiment of FIG. 4, the memory 450 is a component of the DNN system 400. In other embodiments, the memory 450 may be external to the DNN system 400 and communicate with the DNN system 400 through a network.

FIG. 5 is a block diagram of the calibration module 430, in accordance with various embodiments. As described above, the calibration module 430 can calibrate confidence of trained DNNs. In the embodiments of FIG. 5, the calibration module 430 includes a logit transformation module 510, a calibration dataset module 520, an optimization module 530, and a validation module 540. In other embodiments, alternative configurations, different or additional components may be included in the calibration module 430. Further, functionality attributed to a component of the calibration module 430 may be accomplished by a different component included in the calibration module 430, a different component in the DNN system 400, or a different system. For instance, the optimization module 530 and the validation module 540 may be integrated into a single module.

The logit transformation module 510 incorporates a calibration function into a trained DNN. The calibration function may be an entropy-based function, such as the logit transformation function described above in conjunction with FIG. 2. The logit transformation module 510 may add the calibration function into an output layer of the trained DNN. The output layer receives logits generated by hidden layers of the trained DNN. The output layer may include a softmax function. The output layer may perform an operation on each logit with the softmax function and the calibration function. The result of the operation may be used to generate the label of an input and a confidence score of the label.

The calibration dataset module 520 obtains a calibration dataset for training the calibration function. In some embodiments, the calibration dataset module 520 receives the calibration dataset from the training module. The calibration dataset may be a subset of a training dataset generated by the training module. The subset may be referred to as a calibration subset. The rest of the training dataset may be referred to as a training subset. The training module 420 may have used the training subset for training the DNN and reserved the calibration subset for the calibration module 430. The calibration subset is not used in the process of training the DNN. The size of the calibration subset, i.e., the number of training samples in the calibration subset, may be smaller than the size of the training subset, i.e., the number of training samples in the training subset. The calibration subset may include 5-10% of the training samples in the training dataset. In other embodiments, the calibration dataset module 520 may generate the calibration dataset. For instance, the calibration dataset module 520 may retrieve calibration samples and ground-truth labels of the calibration samples from an external system.

The optimization module 530 trains the calibration function by using the calibration dataset. The optimization module 530 may input calibration samples in the calibration dataset into the trained DNN. The trained DNN generates labels of the calibration samples. The optimization module 530 may adjust values of learnable parameters inside the calibration function based on the labels generated by the trained DNN and the ground-truth labels of the calibration samples. In some embodiments, the optimization module 530 defines an optimization problem that seeks to minimize miscalibrations of the trained DNN. In an embodiment, the optimization module 530 uses a NLL function, which can measure the quality of a probabilistic model (e.g., the trained DNN). Given a probabilistic model \hat{π}(Y|X) and n samples, the NLL function may be denoted as:

$$NLL = - {\sum }_{i = 1}^{n} log ( \hat{π} ( {y}_{i} \vert {x}_{i} ) )$$

The optimization module 540 minimizes the NLL. In some embodiments, the NLL is minimized when \hat{π}(Y|X) recovers the ground-truth conditional distribution π(Y|X). In an embodiment where the calibration function is a logit transformation function including two learnable parameters τ₀ and τ₁, the optimization module 530 may tune the learnable parameters τ₀ and τ₁ by solving:

argmin_{τ}_{₀}_{>0,τ}_{₁}_{>0}NLL

In some embodiments, the optimization module 540 may confine a range of the value of the learnable parameter τ₀ or τ₁ so that the adjustment of the value of the learnable parameter is within the range during the training of the calibration function. In an example, the range may be above zero so that the final values of the two learnable parameter will be above zero. In some embodiments, the optimization module 540 may use the same confining range for both learnable parameters τ₀ and τ₁.

The validation module 540 verifies an accuracy of the trained DNN. In some embodiments, the validation module 540 may use the calibration dataset to verify the accuracy of the trained DNN. The accuracy of the trained DNN may be indicated by a ratio of the number of calibration samples that the classification network correctly classified to the total number of calibration samples in the calibration dataset. In some embodiments, at least a portion of the verification of the accuracy and at least a portion of the training of the calibration function may be performed in a single process. For instance, the validation module 540 may use the labels of the calibration samples, which are generated by the trained DNN after the optimization module 530 input the calibration samples into the trained DNN, to verify the accuracy.

In other embodiments, the validation module 540 uses a validation dataset, which may be different from the calibration dataset, to verify the accuracy. The validation module 540 may input samples in the validating dataset (“validation samples”) into the trained DNN and uses the labels of the validation samples generated by the trained DNN to verify the accuracy. In some embodiments, the validation dataset may be formed of some or all the samples in the training dataset. Additionally or alternatively, the validation dataset includes additional samples, other than those in the training sets.

In some embodiments, the validation module 540 may determine an accuracy score measuring the precision, recall, or a combination of precision and recall of the DNN. The validation module 540 may use the following metrics to determine the accuracy score: Precision=TP/(TP+FP) and Recall=TP/(TP+FN), where precision may be how many validation samples the trained DNN correctly classified (TP or true positives) out of all the validation samples it classified (TP+FP or false positives), and recall may be how many the validation samples the trained DNN correctly classified (TP) out of the total number of validation samples that did fall into the classification (TP+FN or false negatives). The F-score (F-score=2*PR/(P+R)) unifies precision and recall into a single measure.

The validation module 540 may compare the accuracy score with a threshold score. In an example where the validation module 540 determines that the accuracy score of the augmented model is lower than the threshold score, the validation module 540 instructs the training module 420 to re-train the DNN. In one embodiment, the training module 420 may iteratively re-train the DNN until the occurrence of a stopping condition, such as the accuracy measurement indication that the DNN may be sufficiently accurate, or a number of training rounds having taken place.

Example Confidence Calibration Method

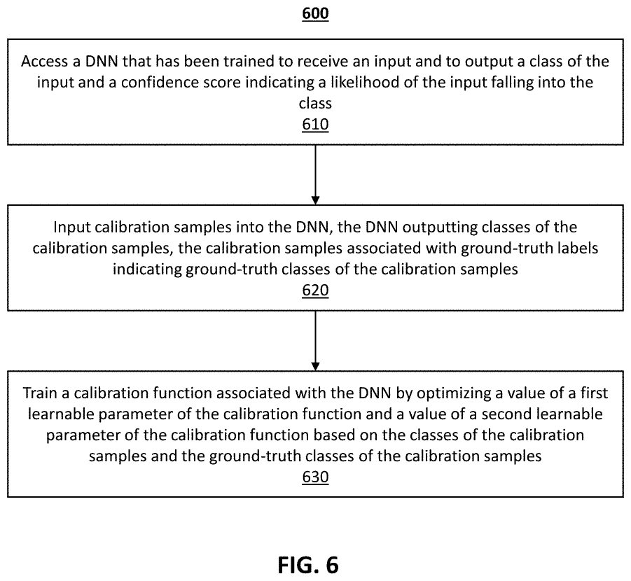

FIG. 6 is a flowchart showing a method 600 of video processing, in accordance with various embodiments. The method 600 may be performed by the calibration module 430 in FIG. 4. Although the method 600 is described with reference to the flowchart illustrated in FIG. 6, many other methods for confidence calibration may alternatively be used. For example, the order of execution of the steps in FIG. 6 may be changed. As another example, some of the steps may be changed, eliminated, or combined.

The calibration module 430 accesses 610 a DNN that has been trained to receive an input and to output a class of the input and a confidence score. The confidence score indicates a likelihood of the input falling into the class. In some embodiments, the DNN includes an input layer, one or more hidden layers, and an output layer.

The calibration module 430 inputs 620 calibration samples into the DNN. The DNN outputs classes of the calibration samples. The calibration samples are associated with ground-truth labels indicating ground-truth classes of the calibration samples.

The calibration module 430 trains 630 a calibration function associated with the DNN by optimizing a value of a first learnable parameter of the calibration function and a value of the second learnable parameter of the calibration function based on the classes of the calibration samples and the ground-truth classes of the calibration samples. In some embodiments, the calibration module 430 trains the calibration function by minimizing a loss between the classes of the calibration samples and the ground-truth classes of the calibration samples. The calibration function after the training is to determine a new confidence score indicating a new likelihood of the input falling into the class.

In some embodiments, the calibration module 430 associates the calibration function with the DNN, e.g., by associating the calibration function with the output layer. The output layer includes a softmax function. The calibration function is a function of an entropy of a vector generated by the plurality of hidden layers.

In some embodiments, the value of the first learnable parameter or the value of the second learnable parameter is above zero. In some embodiments, a value of the new confidence score decreases as the value of the first learnable parameter or the value of the second learnable parameter increases.

In some embodiments, the calibration module 430 verifies an accuracy of the DNN based on the classes of the calibration samples and the ground-truth classes of the calibration samples. The accuracy may be indicated by a ratio of a number of one or more calibration samples that the DNN correctly classified to a total number of the calibration samples. An accuracy of the DNN before training the calibration function may be the same as an accuracy of the DNN after training the calibration function.

In some embodiments, the DNN has been trained by inputting a plurality of training samples into the DNN. The DNN outputs classifications of the training samples. The training samples are associated with ground-truth labels indicating ground-truth classes of the training samples. The DNN is trained by optimizing values of internal parameters of the DNN based on the classes the training samples and the ground-truth classes of the training samples. The training samples are different from the calibration samples.

Example DNN

FIG. 7 illustrates an example DNN 700, in accordance with various embodiments. For purpose of illustration, the DNN 700 in FIG. 7 is a CNN. In other embodiments, the DNN 700 may be other types of DNNs. The DNN 700 is trained to receive images and output classifications of objects in the images. In the embodiments of FIG. 7, the DNN 700 receives an input image 705 that includes objects 715, 725, and 735. The DNN 700 includes a sequence of layers comprising a plurality of convolutional layers 710 (individually referred to as “convolutional layer 710”), a plurality of pooling layers 720 (individually referred to as “pooling layer 720”), and a plurality of fully connected layers 730 (individually referred to as “fully connected layer 730”). In other embodiments, the DNN 700 may include fewer, more, or different layers. In an inference of the DNN 700, the layers of the DNN 700 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 710 summarize the presence of features in the input image 705. The convolutional layers 710 function as feature extractors. The first layer of the DNN 700 is a convolutional layer 710. In an example, a convolutional layer 710 performs a convolution on an input tensor 740 (also referred to as input feature map (IFM) 740) and a filter 750. As shown in FIG. 7, the IFM 740 is represented by a 7×7×3 three-dimensional (3D) matrix. The IFM 740 includes 3 input channels, each of which is represented by a 7×7 two-dimensional (2D) matrix. The 7×7 2D matrix includes 7 input elements (also referred to as input points) in each row and 7 input elements in each column. The filter 750 is represented by a 3×3×3 3D matrix. The filter 750 includes 3 kernels, each of which may correspond to a different input channel of the IFM 740. A kernel is a 2D matrix of weights, where the weights are arranged in columns and rows. A kernel can be smaller than the IFM. In the embodiments of FIG. 7, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 750 in extracting features from the IFM 740.

The convolution includes MAC operations with the input elements in the IFM 740 and the weights in the filter 750. The convolution may be a standard convolution 763 or a depthwise convolution 783. In the standard convolution 763, the whole filter 750 slides across the IFM 740. All the input channels are combined to produce an output tensor 760 (also referred to as output feature map (OFM) 760). The OFM 760 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 7. In embodiments where there are multiple filters, the standard convolution may produce multiple output channels in the OFM 760.

The multiplication applied between a kernel-sized patch of the IFM 740 and a kernel may be a dot product. A dot product is the elementwise multiplication between the kernel-sized patch of the IFM 740 and the corresponding kernel, which is then summed, always resulting in a single value. Because it results in a single value, the operation is often referred to as the “scalar product.” Using a kernel smaller than the IFM 740 is intentional as it allows the same kernel (set of weights) to be multiplied by the IFM 740 multiple times at different points on the IFM 740. Specifically, the kernel is applied systematically to each overlapping part or kernel-sized patch of the IFM 740, left to right, top to bottom. The result from multiplying the kernel with the IFM 740 one time is a single value. As the kernel is applied multiple times to the IFM 740, the multiplication result is a 2D matrix of output elements. As such, the 2D output matrix (i.e., the OFM 760) from the standard convolution 763 is referred to as an OFM.

In the depthwise convolution 783, the input channels are not combined. Rather, MAC operations are performed on an individual input channel and an individual kernel and produce an output channel. As shown in FIG. 7, the depthwise convolution 783 produces a depthwise output tensor 780. The depthwise output tensor 780 is represented by a 5×5×3 3D matrix. The depthwise output tensor 780 includes 3 output channels, each of which is represented by a 5×5 2D matrix. The 5×5 2D matrix includes 5 output elements in each row and 5 output elements in each column. Each output channel is a result of MAC operations of an input channel of the IFM 740 and a kernel of the filter 750. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 793 is then performed on the depthwise output tensor 780 and a 7×1×3 tensor 790 to produce the OFM 760.

The OFM 760 is then passed to the next layer in the sequence. In some embodiments, the OFM 760 is passed through an activation function. An example activation function is the rectified linear activation function (ReLU). ReLU is a calculation that returns the value provided as input directly, or the value zero if the input is zero or less. The convolutional layer 710 may receive several images as input and calculate the convolution of each of them with each of the kernels. This process can be repeated several times. For instance, the OFM 760 is passed to the subsequent convolutional layer 710 (i.e., the convolutional layer 710 following the convolutional layer 710 generating the OFM 760 in the sequence). The subsequent convolutional layers 710 performs a convolution on the OFM 760 with new kernels and generates a new feature map. The new feature map may also be normalized and resized. The new feature map can be kernelled again by a further subsequent convolutional layer 710, and so on.

In some embodiments, a convolutional layer 710 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 710). The convolutional layers 710 may perform various types of convolutions, such as 2-dimensional convolution, dilated or atrous convolution, spatial separable convolution, depthwise separable convolution, transposed convolution, and so on. The DNN 700 includes 76 convolutional layers 710. In other embodiments, the DNN 700 may include a different number of convolutional layers.

The pooling layers 720 down-sample feature maps generated by the convolutional layers, e.g., by summarizing the presence of features in the patches of the feature maps. A pooling layer 720 is placed between 2 convolution layers 710: a preceding convolutional layer 710 (the convolution layer 710 preceding the pooling layer 720 in the sequence of layers) and a subsequent convolutional layer 710 (the convolution layer 710 subsequent to the pooling layer 720 in the sequence of layers). In some embodiments, a pooling layer 720 is added after a convolutional layer 710, e.g., after an activation function (e.g., ReLU) has been applied to the OFM 760.

A pooling layer 720 receives feature maps generated by the preceding convolution layer 710 and applies a pooling operation to the feature maps. The pooling operation reduces the size of the feature maps while preserving their important characteristics. Accordingly, the pooling operation improves the efficiency of the DNN and avoids over-learning. The pooling layers 720 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 720 applied to a feature map of 6×6 results in an output pooled feature map of 3×3. The output of the pooling layer 720 is inputted into the subsequent convolution layer 710 for further feature extraction. In some embodiments, the pooling layer 720 operates upon each feature map separately to create a new set of the same number of pooled feature maps.

The fully connected layers 730 are the last layers of the DNN. The fully connected layers 730 may be convolutional or not. The fully connected layers 730 receive an input operand. The input operand defines the output of the convolutional layers 710 and pooling layers 720 and includes the values of the last feature map generated by the last pooling layer 720 in the sequence. The fully connected layers 730 apply a linear combination and an activation function to the input operand and generate a vector. The vector may contain as many elements as there are classes: element i represents the probability that the image belongs to class i. Each element is therefore between 0 and 7, and the sum of all is worth one. These probabilities are calculated by the last fully connected layer 730 by using a logistic function (binary classification) or a softmax function (multi-class classification) as an activation function.

In some embodiments, the fully connected layers 730 classify the input image 705 and return an operand of size N, where N is the number of classes in the image classification problem. In the embodiments of FIG. 7, N equals 3, as there are 3 objects 715, 725, and 735 in the input image. Each element of the operand indicates the probability for the input image 705 to belong to a class. To calculate the probabilities, the fully connected layers 730 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 715 being a tree, a second probability indicating the object 725 being a car, and a third probability indicating the object 735 being a person. In other embodiments where the input image 705 includes different objects or a different number of objects, the individual values can be different.

Example Deep Learning Environment

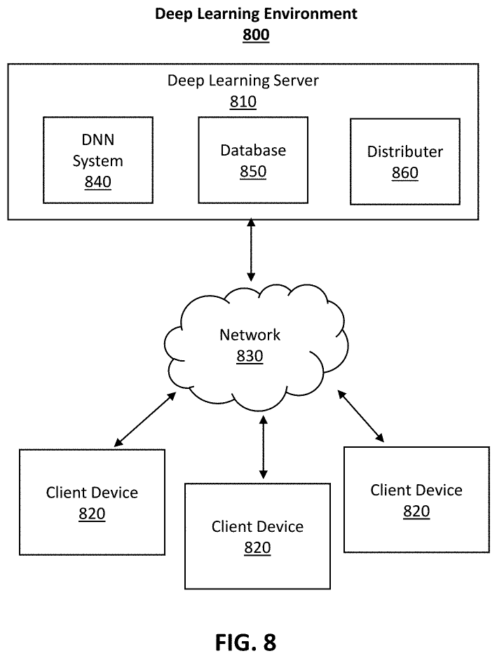

FIG. 8 illustrates a deep learning environment 800, in accordance with various embodiments. The deep learning environment 800 includes a deep learning server 810 and a plurality of client devices 820 (individually referred to as client device 820). The deep learning server 810 is connected to the client devices 820 through a network 830. In other embodiments, the deep learning environment 800 may include fewer, more, or different components.

The deep learning server 810 trains deep learning models using neural networks. A neural network is structured like the human brain and consists of artificial neurons, also known as nodes. These nodes are stacked next to each other in 3 types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The deep learning server 810 can use various types of neural networks, such as DNN, RNN, generative adversarial network (GAN), long short-term memory network (LSTMN), and so on. During the process of training the deep learning models, the neural networks use unknown elements in the input distribution to extract features, group objects, and discover useful data patterns. The deep learning models can be used to solve various problems, e.g., making predictions, classifying images, and so on. The deep learning server 810 may build deep learning models specific to particular types of problems that need to be solved. A deep learning model is trained to receive an input and outputs the solution to the particular problem.

In FIG. 8, the deep learning server 810 includes a DNN system 840, a database 850, and a distributer 860. The DNN system 840 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 900 described above in conjunction with FIG. 9. In some embodiments, the DNN system 840 trains DNNs through knowledge distillation, e.g., dense-connection based knowledge distillation. The trained DNNs may be used on low memory systems, like mobile phones, IOT edge devices, and so on.

The database 850 stores data received, used, generated, or otherwise associated with the deep learning server 810. For example, the database 850 stores a training dataset that the DNN system 840 uses to train DNNs. In an embodiment, the training dataset is an image gallery that can be used to train a DNN for classifying images. The training dataset may include data received from the client devices 820. As another example, the database 850 stores hyperparameters of the neural networks built by the deep learning server 810.

The distributer 860 distributes deep learning models generated by the deep learning server 810 to the client devices 820. In some embodiments, the distributer 860 receives a request for a DNN from a client device 820 through the network 830. The request may include a description of a problem that the client device 820 needs to solve. The request may also include information of the client device 820, such as information describing available computing resource on the client device. The information describing available computing resource on the client device 820 can be information indicating network bandwidth, information indicating available memory size, information indicating processing power of the client device 820, and so on. In an embodiment, the distributer may instruct the DNN system 840 to generate a DNN in accordance with the request. The DNN system 840 may generate a DNN based on the information in the request. For instance, the DNN system 840 can determine the structure of the DNN and/or train the DNN in accordance with the request.

In another embodiment, the distributer 860 may select the DNN from a group of pre-existing DNNs based on the request. The distributer 860 may select a DNN for a particular client device 820 based on the size of the DNN and available resources of the client device 820. In embodiments where the distributer 860 determines that the client device 820 has limited memory or processing power, the distributer 860 may select a compressed DNN for the client device 820, as opposed to an uncompressed DNN that has a larger size. The distributer 860 then transmits the DNN generated or selected for the client device 820 to the client device 820.

In some embodiments, the distributer 860 may receive feedback from the client device 820. For example, the distributer 860 receives new training data from the client device 820 and may send the new training data to the DNN system 840 for further training the DNN. As another example, the feedback includes an update of the available computing resource on the client device 820. The distributer 860 may send a different DNN to the client device 820 based on the update. For instance, after receiving the feedback indicating that the computing resources of the client device 820 have been reduced, the distributer 860 sends a DNN of a smaller size to the client device 820.

The client devices 820 receive DNNs from the distributer 860 and applies the DNNs to perform machine learning tasks, e.g., to solve problems or answer questions. In various embodiments, the client devices 820 input images into the DNNs and use the output of the DNNs for various applications, e.g., visual reconstruction, augmented reality, robot localization and navigation, medical diagnosis, weather prediction, and so on. A client device 820 may be one or more computing devices capable of receiving user input as well as transmitting and/or receiving data via the network 830. In one embodiment, a client device 820 is a conventional computer system, such as a desktop or a laptop computer. Alternatively, a client device 820 may be a device having computer functionality, such as a personal digital assistant (PDA), a mobile telephone, a smartphone, an autonomous vehicle, or another suitable device. A client device 820 is configured to communicate via the network 830. In one embodiment, a client device 820 executes an application allowing a user of the client device 820 to interact with the deep learning server 810 (e.g., the distributer 860 of the deep learning server 810). The client device 820 may request DNNs or send feedback to the distributer 860 through the application. For example, a client device 820 executes a browser application to enable interaction between the client device 820 and the deep learning server 810 via the network 830. In another embodiment, a client device 820 interacts with the deep learning server 810 through an application programming interface (API) running on a native operating system of the client device 820, such as IOS® or ANDROID™.

In an embodiment, a client device 820 is an integrated computing device that operates as a standalone network-enabled device. For example, the client device 820 includes display, speakers, microphone, camera, and input device. In another embodiment, a client device 820 is a computing device for coupling to an external media device such as a television or other external display and/or audio output system. In this embodiment, the client device 820 may couple to the external media device via a wireless interface or wired interface (e.g., an HDMI (High-Definition Multimedia Interface) cable) and may utilize various functions of the external media device such as its display, speakers, microphone, camera, and input devices. Here, the client device 820 may be configured to be compatible with a generic external media device that does not have specialized software, firmware, or hardware specifically for interacting with the client device 820.

The network 830 supports communications between the deep learning server 810 and client devices 820. The network 830 may comprise any combination of local area and/or wide area networks, using both wired and/or wireless communication systems. In one embodiment, the network 830 may use standard communications technologies and/or protocols. For example, the network 830 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 830 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 830 may be represented using any suitable format, such as hypertext markup language (HTML) or extensible markup language (XML). In some embodiments, all or some of the communication links of the network 830 may be encrypted using any suitable technique or techniques.

Example Computing Device

FIG. 9 is a block diagram of an example computing device 900, in accordance with various embodiments. In some embodiments, the computing device 900 can be used as the DNN system 400 in FIG. 4. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include an audio input device 918 or an audio output device 908, but may include audio input or output device interface circuitry (e.g., connectors and supporting circuitry) to which an audio input device 918 or audio output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 904 may include memory that shares a die with the processing device 902. In some embodiments, the memory 904 includes one or more non-transitory computer-readable media storing instructions executable to perform operations for confidence calibration, e.g., the method 600 described above in conjunction with FIG. 6 or some operations performed by the calibration module 430 described above in conjunction with FIG. 4. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include an audio output device 908 (or corresponding interface circuitry, as discussed above). The audio output device 908 may include any device that generates an audible indicator, such as speakers, headsets, or earbuds, for example.

The computing device 900 may include an audio input device 918 (or corresponding interface circuitry, as discussed above). The audio input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include an audio codec, a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

### Select Examples

The following paragraphs provide various examples of the embodiments disclosed herein.

Example 1 provides a method, including accessing a DNN that has been trained to receive an input and to output a class of the input and a confidence score indicating a likelihood of the input falling into the class; inputting calibration samples into the DNN, the DNN outputting classes of the calibration samples, the calibration samples associated with ground-truth labels indicating ground-truth classes of the calibration samples; and training a calibration function associated with the DNN by optimizing a value of a first learnable parameter of the calibration function and a value of a second learnable parameter of the calibration function based on the classes of the calibration samples and the ground-truth classes of the calibration samples, where the calibration function after the training is to determine a new confidence score indicating a new likelihood of the input falling into the class.

Example 2 provides the method of example 1, where training the calibration function includes optimizing the value of the first learnable parameter and the value of the second learnable parameter by minimizing a loss between the classes of the calibration samples and the ground-truth classes of the calibration samples.

Example 3 provides the method of example 1 or 2, where the value of the first learnable parameter or the value of the second learnable parameter is above zero.

Example 4 provides the method of any of the preceding examples, where a value of the new confidence score decreases as the value of the first learnable parameter or the value of the second learnable parameter increases.

Example 5 provides the method of any of the preceding examples, where the DNN includes an input layer, one or more hidden layers, and an output layer, and associating the calibration function with the DNN includes associating the calibration function with the output layer.

Example 6 provides the method of example 5, where the calibration function is a function of an entropy of a vector generated by the plurality of hidden layers.

Example 7 provides the method of example 5 or 6, where the output layer includes a softmax function that determines the likelihood of the input falling into the class.

Example 8 provides the method of any of the preceding examples, further including verifying an accuracy of the DNN based on the classes of the calibration samples and the ground-truth classes of the calibration samples, the accuracy indicated by a ratio of a number of one or more calibration samples that the DNN correctly classified to a total number of the calibration samples.

Example 9 provides the method of any of the preceding examples, where an accuracy of the DNN before training the calibration function is the same as an accuracy of the DNN after training the calibration function.

Example 10 provides the method of any of the preceding examples, where the DNN has been trained by inputting a plurality of training samples into the DNN, the DNN outputting classes of the training samples, the training samples associated with ground-truth labels indicating ground-truth classes of the training samples; and optimizing values of internal parameters of the DNN based on the classes of the training samples and the ground-truth classes of the training samples, where the training samples are different from the calibration samples.

Example 11 provides one or more non-transitory computer-readable media storing instructions executable to perform operations, the operations including accessing a DNN that has been trained to receive an input and to output a class of the input and a confidence score indicating a likelihood of the input falling into the class; inputting calibration samples into the DNN, the DNN outputting classes of the calibration samples, the calibration samples associated with ground-truth labels indicating ground-truth classes of the calibration samples; and training a calibration function associated with the DNN by optimizing a value of a first learnable parameter of the calibration function and a value of a second learnable parameter of the calibration function based on the classes of the calibration samples and the ground-truth classes of the calibration samples, where the calibration function after the training is to determine a new confidence score indicating a new likelihood of the input falling into the class.

Example 12 provides the one or more non-transitory computer-readable media of example 11, where training the calibration function includes optimizing the value of the first learnable parameter and the value of the second learnable parameter by minimizing a loss between the classes of the calibration samples and the ground-truth classes of the calibration samples.

Example 13 provides the one or more non-transitory computer-readable media of example 11 or 12, where the value of the first learnable parameter or the value of the second learnable parameter is above zero.

Example 14 provides the one or more non-transitory computer-readable media of any one of examples 11-13, where a value of the new confidence score decreases as the value of the first learnable parameter or the value of the second learnable parameter increases.

Example 15 provides the one or more non-transitory computer-readable media of any one of examples 11-14, where the DNN includes an input layer, one or more hidden layers, and an output layer, and associating the calibration function with the DNN includes associating the calibration function with the output layer.

Example 16 provides the one or more non-transitory computer-readable media of example 15, where the calibration function is a function of an entropy of a vector generated by the plurality of hidden layers.

Example 17 provides the one or more non-transitory computer-readable media of example 15 or 16, where the output layer includes a softmax function that determines the likelihood of the input falling into the class.

Example 18 provides the one or more non-transitory computer-readable media of any one of examples 11-17, where the operations further include verifying an accuracy of the DNN based on the classes of the calibration samples and the ground-truth classes of the calibration samples, the accuracy indicated by a ratio of a number of one or more calibration samples that the DNN correctly classified to a total number of the calibration samples.

Example 19 provides the one or more non-transitory computer-readable media of any one of examples 11-18, where an accuracy of the DNN before training the calibration function is the same as an accuracy of the DNN after training the calibration function.

Example 20 provides the one or more non-transitory computer-readable media of any one of examples 11-19, where the DNN has been trained by inputting a plurality of training samples into the DNN, the DNN outputting classes of the training samples, the training samples associated with ground-truth labels indicating ground-truth classes of the training samples; and optimizing values of internal parameters of the DNN based on the classes of the training samples and the ground-truth classes of the training samples, where the training samples are different from the calibration samples.

Example 21 provides an apparatus, the apparatus including a computer processor for executing computer program instructions; and a non-transitory computer-readable memory storing computer program instructions executable by the computer processor to perform operations including accessing a DNN that has been trained to receive an input and to output a class of the input and a confidence score indicating a likelihood of the input falling into the class, inputting calibration samples into the DNN, the DNN outputting classes of the calibration samples, the calibration samples associated with ground-truth labels indicating ground-truth classes of the calibration samples, and training a calibration function associated with the DNN by optimizing a value of a first learnable parameter of the calibration function and a value of a second learnable parameter of the calibration function based on the classes of the calibration samples and the ground-truth classes of the calibration samples, where the calibration function after the training is to determine a new confidence score indicating a new likelihood of the input falling into the class.

Example 22 provides the apparatus of example 21, where training the calibration function includes optimizing the value of the first learnable parameter and the value of the second learnable parameter by minimizing a loss between the classes of the calibration samples and the ground-truth classes of the calibration samples.

Example 23 provides the apparatus of example 21 or 22, where the value of the first learnable parameter or the value of the second learnable parameter is above zero.

Example 24 provides the apparatus of any one of examples 21-23, where the DNN includes an input layer, one or more hidden layers, and an output layer, and associating the calibration function with the DNN includes associating the calibration function with the output layer.

Example 25 provides the apparatus of any one of examples 21-24, where the DNN has been trained by inputting a plurality of training samples into the DNN, the DNN outputting classes of the training samples, the training samples associated with ground-truth labels indicating ground-truth classes of the training samples; and optimizing values of internal parameters of the DNN based on the classes of the training samples and the ground-truth classes of the training samples, where the training samples are different from the calibration samples.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method, comprising:
accessing a deep neural network (DNN) that has been trained to receive an input and to output a class of the input and a confidence score indicating a likelihood of the input falling into the class;
inputting calibration samples into the DNN, the DNN outputting classes of the calibration samples, the calibration samples associated with ground-truth labels indicating ground-truth classes of the calibration samples; and
training a calibration function associated with the DNN by optimizing a value of a first learnable parameter of the calibration function and a value of a second learnable parameter of the calibration function based on the classes of the calibration samples and the ground-truth classes of the calibration samples,
wherein the calibration function after the training is to determine a new confidence score indicating a new likelihood of the input falling into the class.

2. The method of claim 1, wherein training the calibration function comprises:
optimizing the value of the first learnable parameter and the value of the second learnable parameter by minimizing a loss between the classes of the calibration samples and the ground-truth classes of the calibration samples.

3. The method of claim 1, wherein the value of the first learnable parameter or the value of the second learnable parameter is above zero.

4. The method of claim 1, wherein a value of the new confidence score decreases as the value of the first learnable parameter or the value of the second learnable parameter increases.

5. The method of claim 1, wherein:
the DNN comprises an input layer, one or more hidden layers, and an output layer, and
associating the calibration function with the DNN comprises associating the calibration function with the output layer.

6. The method of claim 5, wherein the calibration function is a function of an entropy of a vector generated by the one or more of hidden layers.

7. The method of claim 5, wherein the output layer includes a softmax function that determines the likelihood of the input falling into the class.

8. The method of claim 1, further comprising:
verifying an accuracy of the DNN based on the classes of the calibration samples and the ground-truth classes of the calibration samples, the accuracy indicated by a ratio of a number of one or more calibration samples that the DNN correctly classified to a total number of the calibration samples.

9. The method of claim 1, wherein an accuracy of the DNN before training the calibration function is the same as an accuracy of the DNN after training the calibration function.

10. The method of claim 1, wherein the DNN has been trained by:
inputting one or more training samples into the DNN, the DNN outputting classes of the one or more training samples, the one or more training samples associated with ground-truth labels indicating ground-truth classes of the one or more training samples; and
optimizing values of internal parameters of the DNN based on the classes of the one or more training samples and the ground-truth classes of the one or more training samples,
wherein the one or more training samples are different from the calibration samples.

11. One or more non-transitory computer-readable media storing instructions executable to perform operations, the operations comprising:
accessing a deep neural network (DNN) that has been trained to receive an input and to output a class of the input and a confidence score indicating a likelihood of the input falling into the class;
inputting calibration samples into the DNN, the DNN outputting classes of the calibration samples, the calibration samples associated with ground-truth labels indicating ground-truth classes of the calibration samples; and
training a calibration function associated with the DNN by optimizing a value of a first learnable parameter of the calibration function and a value of a second learnable parameter of the calibration function based on the classes of the calibration samples and the ground-truth classes of the calibration samples,
wherein the calibration function after the training is to determine a new confidence score indicating a new likelihood of the input falling into the class.

12. The one or more non-transitory computer-readable media of claim 11, wherein training the calibration function comprises:
optimizing the value of the first learnable parameter and the value of the second learnable parameter by minimizing a loss between the classes of the calibration samples and the ground-truth classes of the calibration samples.

13. The one or more non-transitory computer-readable media of claim 11, wherein the value of the first learnable parameter or the value of the second learnable parameter is above zero.

14. The one or more non-transitory computer-readable media of claim 11, wherein a value of the new confidence score decreases as the value of the first learnable parameter or the value of the second learnable parameter increases.

15. The one or more non-transitory computer-readable media of claim 11, wherein:
the DNN comprises an input layer, one or more hidden layers, and an output layer, and
associating the calibration function with the DNN comprises associating the calibration function with the output layer.

16. The one or more non-transitory computer-readable media of claim 15, wherein the calibration function is a function of an entropy of a vector generated by the plurality of hidden layers.

17. The one or more non-transitory computer-readable media of claim 15, wherein the output layer includes a softmax function that determines the likelihood of the input falling into the class.

18. The one or more non-transitory computer-readable media of claim 11, wherein the operations further comprise:
verifying an accuracy of the DNN based on the classes of the calibration samples and the ground-truth classes of the calibration samples, the accuracy indicated by a ratio of a number of one or more calibration samples that the DNN correctly classified to a total number of the calibration samples.

19. The one or more non-transitory computer-readable media of claim 11, wherein an accuracy of the DNN before training the calibration function is the same as an accuracy of the DNN after training the calibration function.

20. The one or more non-transitory computer-readable media of claim 11, wherein the DNN has been trained by:
inputting a plurality of training samples into the DNN, the DNN outputting classes of the training samples, the training samples associated with ground-truth labels indicating ground-truth classes of the training samples; and
optimizing values of internal parameters of the DNN based on the classes of the training samples and the ground-truth classes of the training samples,
wherein the training samples are different from the calibration samples.

21. An apparatus, comprising:
a computer processor for executing computer program instructions; and
a non-transitory computer-readable memory storing computer program instructions executable by the computer processor to perform operations comprising:
accessing a deep neural network (DNN) that has been trained to receive an input and to output a class of the input and a confidence score indicating a likelihood of the input falling into the class,
inputting calibration samples into the DNN, the DNN outputting classes of the calibration samples, the calibration samples associated with ground-truth labels indicating ground-truth classes of the calibration samples, and
training a calibration function associated with the DNN by optimizing a value of a first learnable parameter of the calibration function and a value of a second learnable parameter of the calibration function based on the classes of the calibration samples and the ground-truth classes of the calibration samples,
wherein the calibration function after the training is to determine a new confidence score indicating a new likelihood of the input falling into the class.

22. The apparatus of claim 21, wherein training the calibration function comprises:
optimizing the value of the first learnable parameter and the value of the second learnable parameter by minimizing a loss between the classes of the calibration samples and the ground-truth classes of the calibration samples.

23. The apparatus of claim 21, wherein the value of the first learnable parameter or the value of the second learnable parameter is above zero.

24. The apparatus of claim 21, wherein:
the DNN comprises an input layer, one or more hidden layers, and an output layer, and
associating the calibration function with the DNN comprises associating the calibration function with the output layer.

25. The apparatus of claim 21, wherein the DNN has been trained by:
inputting a plurality of training samples into the DNN, the DNN outputting classes of the training samples, the training samples associated with ground-truth labels indicating ground-truth classes of the training samples; and
optimizing values of internal parameters of the DNN based on the classes of the training samples and the ground-truth classes of the training samples,
wherein the training samples are different from the calibration samples.
